(19) United States
(12) Patent Application Publication
(10) Pub. No.: US 2017/0334047 A1
(43) Pub. Date: Nov. 23, 2017

(54) DOOR HINGE PIN REMOVAL DEVICE

(71) Applicant: KOP TOOLS NO.9659978 CANADA INC., St-Hubert (CA)

(72) Inventor: Roger FALLS, Richelieu (CA)

(21) Appl. No.: 15/674,986

(22) Filed: Aug. 11, 2017

Related U.S. Application Data
(63) Continuation of application No. PCT/CA2016/000029, filed on Feb. 4, 2016.
(60) Provisional application No. 62/114,651, filed on Feb. 11, 2015.

(51) Int. Cl. B25B 27/04; E05D 11/10; E05D 3/02

(52) U.S. Cl. CPC B25B 27/04; E05D 11/10; E05D 3/02

(57) ABSTRACT

A device for removing a hinge pin includes a body, a slide pin mounted to the body for first sliding movement relative thereto between a neutral and an extended longitudinal position along the body, an impactor coupled to the slide pin for second movement in unison with the first movement, and a biasing member, coupled to both the slide pin and the body, for biasing the slide pin towards the neutral position relative to the body. In operation, while i) the impactor is registered with the hinge pin and is distanced therefrom and ii) the slide pin is moved away from the neutral longitudinal position, releasing the slide pin causes a) the slide pin to move towards the neutral position by the biasing member and b) the impactor to impact the hinge pin.

### CROSS-REFERENCE TO RELATED APPLICATIONS

This application is a continuation of International Application PCT/CA2016/000029, filed Feb. 4, 2016, which claims the benefit of U.S. Provisional Application No. 62/114,651, filed on Feb. 11, 2015, the contents of each of which are incorporated by reference herein.

### FIELD

The present disclosure relates to hand tools. More specifically, the present disclosure relates to a device for removing the pin of a door hinge.

### BACKGROUND

The conventional way to remove the pin of a door hinge is to hit the pin with a hammer using a punch until it is dislodged from the hinge. The efficiency of this conventional method is limited by the strength of the person proceeding, and the space available under the hinge. Other drawbacks of this conventional method includes the lack of precisions, the possibilities of injury and of causing damage to the door.

The following tools have been proposed to replace the traditional punch in view of solving some of the above-mentioned drawbacks:

| Patent/Appl. No | Title | Inventor | Date |
|---|---|---|---|
| U.S. Pat. No. 7,971,329 B1 | Hinge Pin Removal Tool | Brohard | 2011 Jul. 5 |
| US 2009/0178263 A1 | Hinge Pin Removal and Attachment Tool | Robberts et al. | 2009 Jul. 16 |
| U.S. Pat. No. 6,351,881 B1 | Hinge Pin Remover and Starter | Peckich et al. | 2002 Mar. 5 |
| U.S. Pat. No. 5,875,535 | Hinge Pin Removal Tool | Canoy | 1999 Mar. 2 |
| U.S. Pat. No. 4,188,701 | Hinge Pin Remover | Ludwig | 1980 Feb. 19 |
| U.S. Pat. No. 4,183,133 | Hine Pintle Removal Tool | Abbott | 1980 Jan. 15 |

However, these tools still involve the use of a hammer and have the inherent drawbacks discussed hereinabove.

Other solutions were also proposed, including the “Semi-Automatic Door Hinge Pin Removal Tool” disclosed in the United States Publ. No. 2005/0268448 A1, published Dec. 8, 2005 and naming Jones as the inventor. This tool does not involve hitting or hammering on the pin. It first creates a prying action that aims at dislodging the hinge pin by pushing on its head and then a secondary hand-powered gear mechanism can allows forcing the pin upwardly out of the hinge barrel. In addition to having many parts and being relatively complex to assemble, Jones' tool operates in two steps which is unintuitive.

U.S. Pat. No. 7,152,293, issued on Dec. 26, 2006 to Abrahamson and titled “Thee Hinge Pin Remover” shows a device for removing a hinge pin from a hinge assembly that can be operated by pushing down on a handle, which rotates a gear wheel that causes a L-shaped arm to push on the hinge pin via another pin. Similarly to Jones' device, the device from Abrahamson is based on the lever principle and requires a minimum of force to be generated by the user.

### SUMMARY

According to an illustrative embodiment, there is provided a device for removing a hinge pin comprising:

a body

a slide pin mounted to the body for first sliding movement relative thereto between neutral and extended longitudinal positions along the body;

an impactor coupled to the slide pin for second movement in unison therewith; and

a biasing member, coupled to both the slide pin and the body, for biasing the slide pin towards the neutral position relative to the body;

whereby, in operation, while i) the impactor is registered with the hinge pin and is distanced therefrom and ii) the slide pin is moved away from the neutral longitudinal position, releasing the slide pin causes a) the slide pin to move towards the neutral position by the biasing member and b) the impactor to impact the hinge pin.

According to another illustrative embodiment, there is provided a device for removing a hinge pin comprising:

a body

a slide pin mounted to the body for first sliding movement between neutral and extended longitudinal positions along the body;

an impactor coupled to the slide pin for second parallel movement in unison therewith;

a spring coaxially mounted about the slide pin and having a first end mounted to the slide pin for solidary movement therewith and a second end abutting a wall within the body; wherein the first sliding movement of the slide pin towards the extended position yields a biasing force onto the slide pin towards the neutral position thereof; and

a trigger mechanism mounted to both the body and the slide pin for selective locking of the slide pin in the extended longitudinal position; wherein the slide pin includes at least one locking portion that is configured for engagement with the trigger mechanism to cause the selective locking;

whereby, in operation, while i) the impactor is registered with the hinge pin and is distanced therefrom and ii) the slide pin is moved away from the neutral longitudinal position, releasing the slide pin causes a) the slide pin to move towards the neutral position by the biasing member and b) the impactor to impact the hinge pin.

Other objects, advantages and features of the device for removing a hinge pin will become more apparent upon reading the following non-restrictive description of preferred embodiments thereof, given by way of example only with reference to the accompanying drawings.

### BRIEF DESCRIPTION OF THE DRAWINGS

In the appended drawings:

FIG. 1A is a front elevation of a door hinge pin removal device according to a first illustrated embodiment; the device being illustrated in its extended configuration;

FIG. 1B is a cross-section taken along line 1B-1B in FIG. 1A;

FIG. 10 is a front elevation of the device from FIG. 1A, showing the neutral configuration thereof;

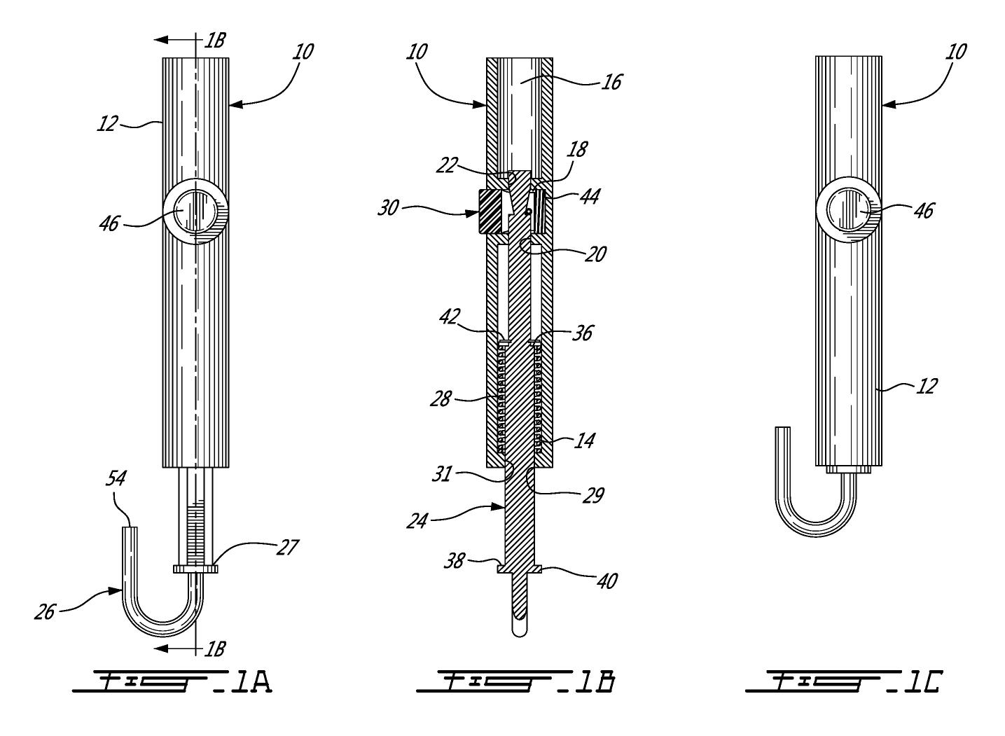

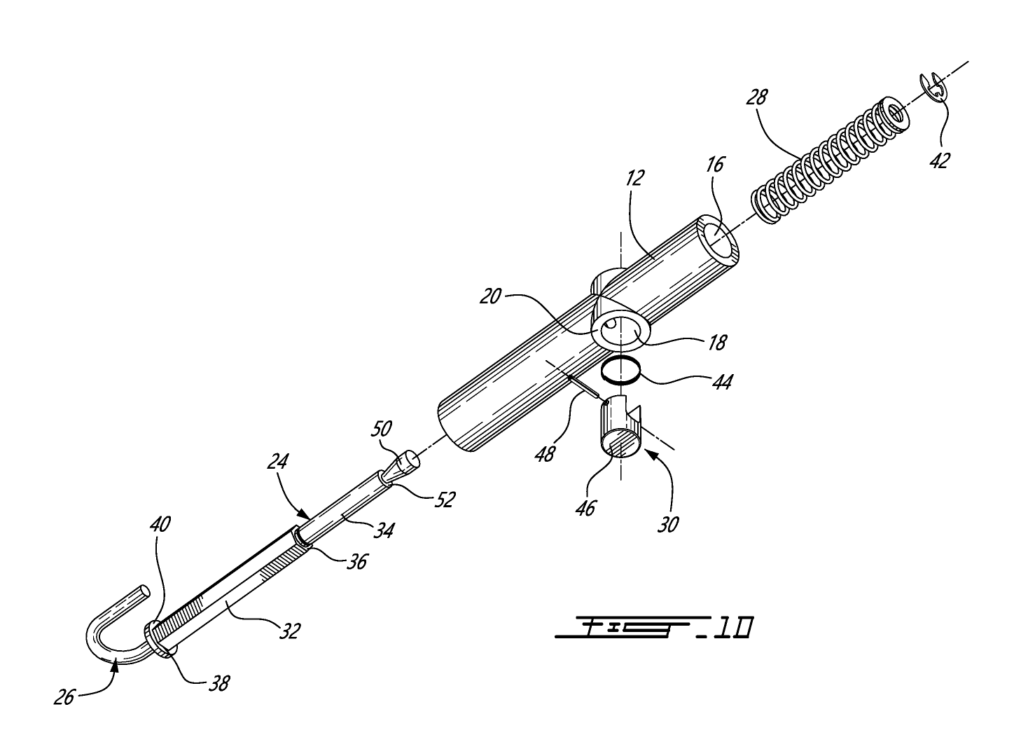

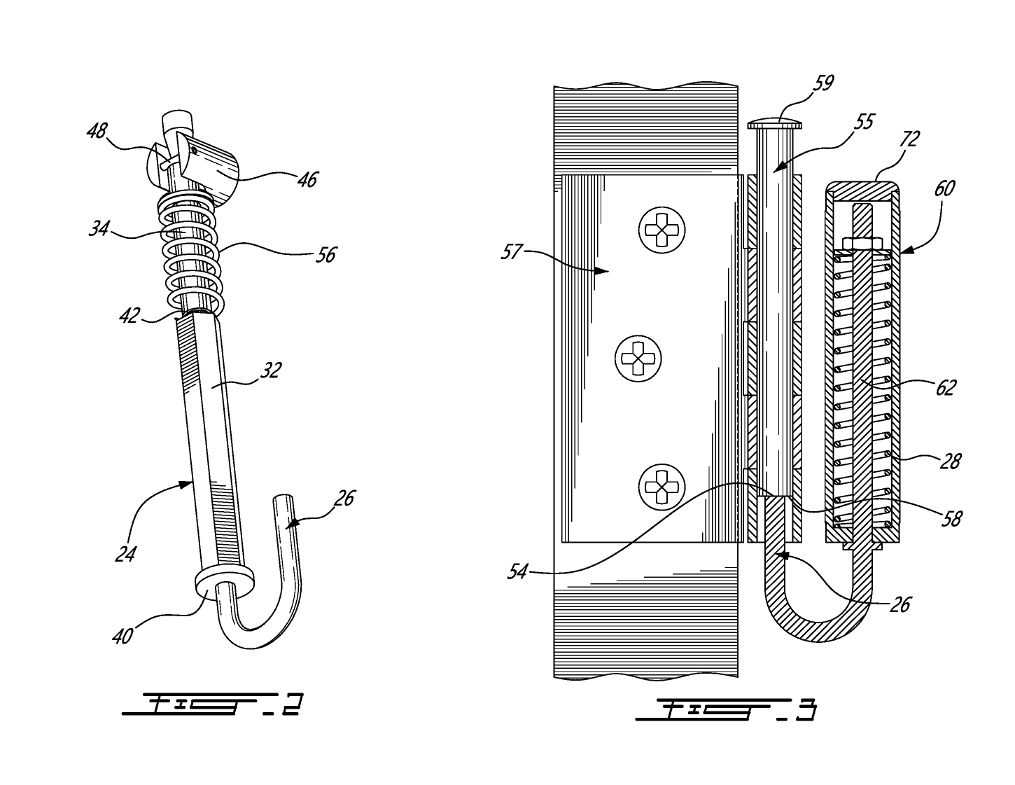

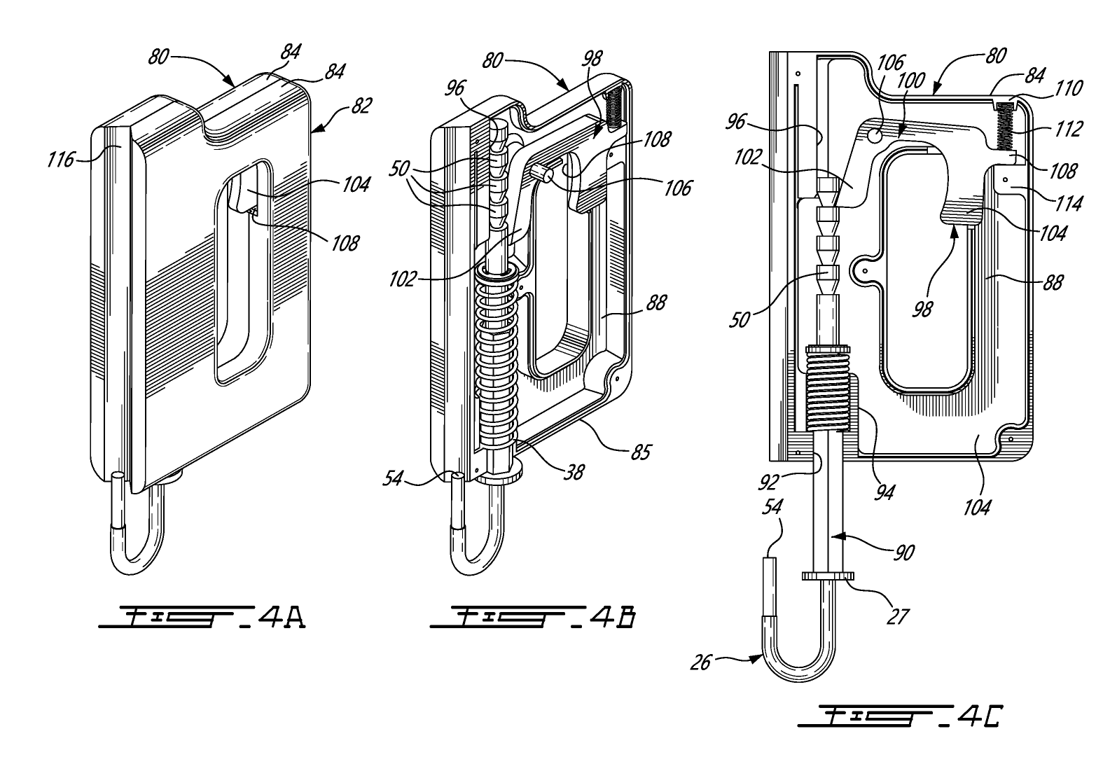

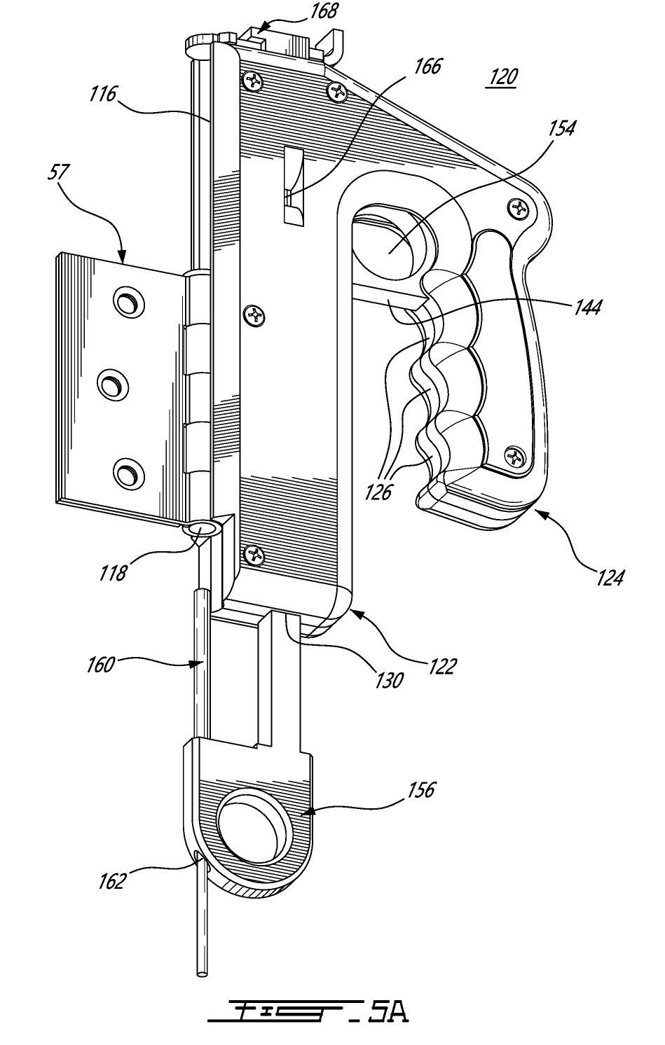

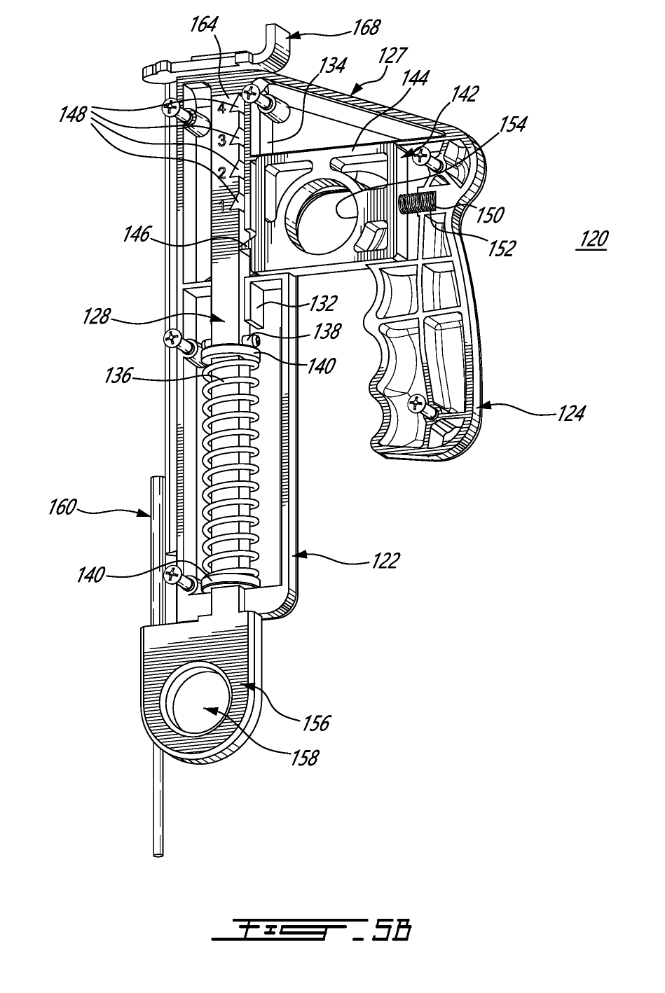

FIG. 1D is an exploded view of the device from FIG. 1A,

FIG. 2 is a perspective view of a door hinge pin removal device according to a second illustrated embodiment; the device being illustrated without its housing body;

FIG. 3 is a cross-section of a door hinge pin removal device according to a third illustrative embodiment; the device being illustrated in operation adjacent a door hinge;

FIG. 4A is a perspective of a door hinge pin removal device according to a fourth illustrated embodiment; the device being illustrated in its neutral configuration;

FIG. 4B is a perspective of the door hinge pin removal device from FIG. 4A, illustrated with its casing opened and showing its mechanism;

FIG. 4C is a cross-section of the device from FIG. 4A, illustrated with its casing opened and show in its extended configuration;

FIG. 5A is a perspective of a door hinge pin removal device according to a fifth illustrated embodiment; the device being illustrated in its extended configuration; and

FIG. 5B is a perspective of the door hinge removal device from FIG. 5A; the device being shown with half it casing removed and in tis neutral configuration.

### DETAILED DESCRIPTION

In the following description, similar features in the drawings have been given similar reference numerals, and in order not to weigh down the figures, some elements are not referred to in some figures if they were already identified in a precedent figure.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements.

A door hinge pin removal device 10 according to a first illustrated embodiment will now be described with reference to FIGS. 1A-1D.

The device 10 comprises an elongated body 12 having first and second co-axial longitudinal chambers 14 and 16 therein and a transversal chamber 18 longitudinally positioned between the two longitudinal chambers 14-16, the transversal chamber 18 having two opposite openings 20-22 that define a passage between the two longitudinal chambers 14-16.

The device 10 also comprises a slide pin 24 that is mounted to the body 12 for longitudinal sliding movement therein between a neutral and an extended or loaded longitudinal position. The pin 24 is configured and sized so as to extend in both longitudinal chambers 14-16. The device 10 further includes a C-shaped impactor 26 that extends from the pin 24 at a first longitudinal end 27 thereof, a biasing element, in the form of a spring 28, that is mounted to the pin 24 in the first longitudinal chamber 14 and that forces the pin 24 in its neutral position when no other force is exerted thereon, and a trigger mechanism 30 mounted in the transversal chamber 18 for selectively locking the pin 24 in its loaded position and for releasing the pin 24 therefrom.

Both longitudinal chambers 14 and 16 have a circular section. The end of the elongated body 12 on the side of the first longitudinal chamber 14 is partially closed by an integral cap 29 having an aperture 31 that is hexagonal in shape.

As can be better seen in FIG. 1D, the elongated pin 24 has a first hexagonal section 32 having a length that corresponds generally to the length of the first longitudinal chamber 14 and a section that snugly complements the aperture 31, and a second narrower section 34 that is circular and that snugly complements the two openings 20-22. This results in the elongated pin 24 snugly fitting in the body 12 when it is inserted through the aperture 31.

The intersection between the first and second sections 32 and 34 of the pin defines a shoulder portion 36 that acts as a mechanical stop to prevent the first section 32 from exiting the first chamber 14 at the end thereof opposite the aperture 31. The end 38 of the first section 32 is also provided with a collar 40 which also acts as a mechanical stop.

The biasing element 28 is in the form of a compression spring and is inserted in the first longitudinal chamber 14. The spring 28 is prevented from exiting the chamber 14 by the cap 29. The length of the spring 28 in its neutral position, i.e. when no force is exerted thereon, is the same or near the length of the first chamber 14.

The end of the circular section 34 of the pin 24 that is adjacent the hexagonal section 32 is threaded and the spring 28 is secured thereto by a retaining ring 42. It results that pulling on the pin 24 causes the spring 28 to be compressed between the end of the hexagonal section 32 and the cap 29, yielding a biasing force that calls back the pin 24 inside the body 12 towards its neutral position.

The trigger mechanism 30 includes a button spring 44 positioned at the bottom of the transversal chamber 18, a button 46 that snugly fits into the chamber 18, for pressing onto the spring 44 when the button 46 is depressed and having two diametrically symmetrical U-shaped notches 47 (see FIG. 1D) for allowing passage for the pin 24 as shown in FIG.1B, and a spring pin 48 transversally mounted into the button 46.

The pin 24 further includes a generally frusto-conical portion 50 that extends from the circular section 34 on the longitudinal side thereof, opposite the section 32. The portion 50 defines a shoulder 52 with the circular section 34. As can be better seen in FIG. 1B, when the slide pin 24 is sufficiently pulled away from the body 12 so as to move the device 10 to its loaded configuration, the shoulder portion 52 passes beyond the spring pin 48 and the pin 24 is prevented from returning to its neutral position by the abutment of the spring pin 48 onto the shoulder 52.

Depressing the button 46 then causes the pin 48 to move beyond the shoulder 52, and the pin 24 automatically retracts within the chamber 14. This causes the tip 54 of the impactor 26 to move in the same direction than the pin 24.

By aligning the tip 54 of the impactor 26 with a pin of a door hinge (not shown) and by providing a distance therebetween that is shorter than the full course of the impactor 26, the device 10 causes the door hinge pin to be dislodged from the hinge by the powerful impact of the impactor tip 54 unto the door hinge pin.

It has been found that providing the device 10 with a compression spring 28 that yields, for example, a pressure of about 28 lbs is sufficient to yield a device 10 that can remove most door hinge pin effortlessly. A person skilled in the art would appreciate that a spring configured to yield more or less pressure can also be used, taking into consideration that a less powerful spring is easier to arm but might be less effective in some application, while a more powerful spring may be more effective in most application but requires more strength to arm.

The hook shape of the impactor 26 and its position relative to the body 12 allow easy positioning of the device 10 relative to a typical door hinge, including the lower hinge of a door wherein space between the hinge and the floor (both not shown) is often limited.

FIG. 2 shows the inner mechanism of a device for dislodging a hinge pin according to a second illustrative embodiment. Since this inner mechanism is similar to the one of the device 10, only the differences therebetween will be described herein in more detail for concision purposes. According to this further embodiment, the biasing element for the pin 24 is in the form of a tension spring 56 that is mounted between the hexagonal section 32 and the button 46.

It is to be noted that many modifications could be made to the device 10 described hereinabove and illustrated in the appended drawings. For example:

the shapes of any section of the pin 24 are not limited to those illustrated. For example, the section 32 can be circular;

the outer or inner shape of the body 12, including the chambers 12, 14 and 18 are not limited to being circular;

the position of the spring 28 can be different than being concentric with the pin 24. For example, it can be positioned at one end thereof or parallel thereto, and the configuration of the encasing body is adjusted accordingly;

the position of the impactor 26 is not limited to being at the longitudinal end of the pin 24. For example, it can be positioned parallel to the body 12, beside thereof. According to such an embodiment, a longitudinal groove (not shown) is provided on the body 12 to allow connection of the impactor 26 to the pin 24;

the impactor 26 and slide pin 24 are not limited to being in a parallel relationship; and

the trigger mechanism can be different than the one illustrated.

Other modifications to the device 10 are also possible as will become more apparent upon reading the following description of further embodiments thereof.

With reference to FIG. 3, a door hinge pin removal device 60 according to a third illustrated embodiment will now be described. Since the device 60 is similar to the device 10, only the differences between both devices 10 and 60 will be described herein for concision purposes.

A main difference between both devices 10 and 60 is the absence in the device 60 of a trigger mechanism. This allows a simpler pin 62, which includes mainly a hexagonal section 64, and a simpler tubular body 66.

A compression spring 28 is mounted to the pin 62 via a nut 68 mounted to a threaded section 70 of the pin 62. Also, the open end of the body 66 is closed by a cap 72.

In operation, the impactor tip 54 is positioned registered with the pin 55 of a door hinge 57 and at the appropriate distance to the tip 58 thereof that is head free. The device 60 is then moved from its neutral configuration to its loaded configuration by pulling on the impactor 26 with one hand while holding the body 66 with the other end. Removing the hand from the impactor 26 while still holding the body 66 causes the forceful impact of the impactor tip 54 onto the door hinge pin 55, that is then forced out of the hinge 57.

A door hinge pin removal device 80 according to a fourth illustrated embodiment will now be described with reference to FIGS. 4A-4C.

Since the device 80 is similar to the device 10, only the differences between both devices 10 and 80 will be described herein for concision purposes.

There are three main differences between the device 80 and the device 10.

As a first difference, the body 82 includes two symmetrically identical side portions 84 that are joined to form a generally O-shaped hollow casing 82. The casing 82 includes a first hollow housing portion 86 and a second hollow handle portion 88. The two side portions 84 are assembled using fasteners (not shown) and/or adhesive.

The casing 82 includes a hexagonal hole 92 and inner walls 94 and 96 together defining a channel that receives the pin 90 for sliding movement therein.

The pin 90 is generally shaped like the pin 24 of the device 10 with, as a difference, that it includes a plurality of consecutive frusto-conical sections 50. This allows a plurality of loaded configurations for the device 80, each one corresponding to the spring 38 being more or less compressed and, therefore, each configuration yielding a different impacting force for the impactor 54.

The device 80 comprises a trigger mechanism 98 that includes a generally C-shaped member 100 that defines a pin-engaging finger 102 and a trigger portion 104. The member 100 is pivotally mounted to both side portions 84 of the casing 82 therebetween via a pivot pin 106 that is positioned at the proximate end of the pin-engaging finger 102.

The casing 82 includes an aperture 108 that allows a portion of the trigger 104 out of the casing and clearance for the movement thereof when the member 100 pivots about the pin 106.

The C-shaped member 100 further includes a rectangular spring-receiving portion 108 that protrudes from the trigger portion 104 near the proximate end thereof on its side opposite the finger 102. The casing 82 includes a ring portion 1 10 that protrudes from the inner surface thereof towards the spring-receiving portion 108 and that receives therein the first end of a biasing element in the form of a compression spring 112. The other end of the spring 112 abuts the spring-receiving portion 108 of the member 100 and biases the member 100 towards a position that both extends the trigger portion 104 out of the casing and forces the finger 102 towards the pin 90. The inner wall of the casing 82 includes a stop 114 that limits the pivotal movement of the member 100 under the biasing force of the spring 112.

In operation, the impactor 26 is pulled from a certain length while holding the casing 80. This causes the pin 90 to be pulled out of the casing 80 from the corresponding length. Passed a certain length of the pin 90 out of the casing 80, the finger 102 sequentially engages the frusto-conical sections 50 until the impactor is stopped being pulled. The pin 90 is locked at the corresponding loaded position until the trigger 104 is pulled.

The impactor 26 is registered with a parallel grooved portion 116 of the casing 85, which receives a portion of the impactor 26 when the device 80 is in its neutral configuration. Such a configuration of the device 80 contributes to ease the operational positioning of the device 80 relative to a door hinge pin to remove (not shown).

While the device 80 is in one of its loaded positions (see FIG. 4C), it is positioned so that the groove 116 abuts the barrel 118 of a hinge 57 (see for example on FIG. 5A). The tip of the impactor 26 is then registered with the hinge pin 55, thereunder.

Pulling the trigger 104 causes the forceful impact of the impactor tip 54 onto the door hinge pin 55, that is then forced out of the hinge 57.

The number, size and/or configuration of the sections 50 may differ to those illustrated.

The pin-engaging finger 102 and trigger portion 104 are not limited to define a C-shaped member or to being integral. According to another embodiment, a coupling assembly is provided to operatively couple the finger and trigger portion.

The configurations of the pin, impactor, handle and trigger mechanism are not limited to the above-described embodiments as will now become apparent with reference to the door hinge pin removal device 120 according to a fifth illustrated embodiment shown in FIGS. 5A-5B. Since the device 120 is similar to the device 80, only the differences between both devices 120 and 80 will be described herein for concision purposes.

The device 120 is shaped like a generally flat gun and includes a first elongated hollow housing portion 122, a second hollow handle portion 124 that includes finger-receiving recesses 126 and an intermediary trapezoid housing portion 127 between the first and second portions 122 and 124.

The pin 128 of the device 120 has a rectangular cross-section and the housing portion 122 includes a rectangular hole 130 for receiving the pin 128 therein. The elongated housing portion 122 further includes inner walls 132 and 134 (only two visible in FIG. 5B) that defines with the hole 30 a pin-receiving channel that laterally restrains the pin 128 and allows longitudinal sliding movements thereof in the housing portion 122.

A first end 136 of the compression spring 38 is fixedly mounted to the pin 128 for sliding movement in unison therewith via a peg 138 secured to the pin 128 transversally therefrom. A washer 140 is mounted onto the pin 128 at each end of the spring 38.

The trigger mechanism 142 includes a rectangular trigger element 144 mounted in the trapezoid housing portion 127 for reciprocal sliding movement therein towards and away from the pin 128.

The trigger element 144 includes a triangular-shaped tooth 146 that extends outwardly from the element 144 towards the pin 128. The pin 128 is provided with notches 148 that are shaped for complementary receiving the tooth 146.

The trigger mechanism 142 further includes a compression spring 150 so mounted in a recess 152 within the hollow handle portion 124 as to contact and bias the trigger element 144 toward the pin 128. It yields that pulling on the pin 128 to move it away from its neutral position (shown in FIG. 5A) causes each of the notches 148 to be engaged sequentially by the tooth 146 of the trigger element 144 until the pin 128 is released. The biasing force of the spring 152 causes the pin 128 to remain locked in the corresponding armed position until the trigger element 144 is moved away from the pin 128 by a user (not shown).

The trigger element 144 includes a finger-receiving aperture 154. The casing of the device 10 is shaped so as to allow the portion of the trigger element 144 surrounding the aperture 154 to protrude therefrom above and adjacent the finger-receiving recesses 126 of the casing.

The end of the pin 128 that extends out of the casing is provided with a handle 156 that includes a finger-receiving hole 158.

The impactor is in the form of a two-section pin 160 that is removably so mounted in the handle 156 as to be registered with the groove 116. The impactor pin 160 has a first wider circular section that extends on about half its length and a second narrower circular section on its second half. This configuration of the impactor pin 160 allows a user choosing the appropriate section depending on the dimension of the hinge pin to dislodge. The handle 156 includes a two-section aperture 162 for snuggly receiving the impactor pin 160. The two sections of the aperture 162 defines a shoulder (not shown) that limits the movement of the impactor pin 160 within the aperture 162.

As a further characteristic, the slide pin 128 is provided with indicia 164 adjacent the notches 148, and the casing of the device 120 includes a window 168 laterally aligned with the indicia to show the indicia of the corresponding locking/armed position of the device 120.

Finally, the device includes a pin stopper 168 so mounted to the casing as to be positioned within the course of the impactor pin 160 at the end of the groove 116. The pin stopper 168 acts as a safety feature that prevents a pin 118 dislodged by the device to become a dangerous projectile.

In operation of the device 120, the handle 156 is pulled from a certain length while holding any part of the casing. This causes the pin 128 to be pulled out of the casing from the corresponding length. Beyond a certain length of the pin 128 out of the casing, the tooth 146 sequentially engages the notches 148 until the pin 128 is stopped being pulled. The pin 128 is locked at the corresponding loaded position until the trigger 144 is pulled. While the device 80 is in such a loaded position (see FIG. 5A), it is positioned adjacent the hinge 57 so that the groove 116 abuts the hinge-receiving channel 118 of the hinge 57. The tip of the impactor 26 is then registered with the hinge pin 55, thereunder.

Pulling the trigger 144 then causes the forceful impact of the impactor 160 onto the door hinge pin 55, that is then forced out of the hinge 57.

Although a hinge pin removal device has been described hereinabove by way of illustrated embodiments thereof, it can be modified. It is therefore to be understood that numerous modifications may be made to the illustrative embodiments and that the scope of the claims should not be limited by the preferred embodiment, but should be given the broadest interpretation consistent with the description as a whole.

What is claimed is:

1. A device for removing a hinge pin comprising:
a body
a slide pin mounted to the body for first sliding movement relative thereto between neutral and extended longitudinal positions along the body;
an impactor coupled to the slide pin for second movement in unison therewith; and
a biasing member, coupled to both the slide pin and the body, for biasing the slide pin towards the neutral position relative to the body;
whereby, in operation, while i) the impactor is registered with the hinge pin and is distanced therefrom and ii) the slide pin is moved away from the neutral longitudinal position, releasing the slide pin causes a) the slide pin to move towards the neutral position by the biasing member and b) the impactor to impact the hinge pin.

2. The device of claim 1, wherein the second movement is generally parallel to the first sliding movement.

3. The device of claim 1, wherein the biasing member is a spring coaxially mounted about the slide pin and having a first end mounted to the slide pin for solidary movement therewith and a second end abutting a wall within the body; wherein the first sliding movement of the slide pin towards the extended position yields a biasing force onto the slide pin towards the neutral position thereof.

4. The device of claim 3, wherein the body is tubular and includes a passage for reciprocal movement of the slide pin within and partially out of the body; the device further comprising a trigger mechanism operatively mounted to the body and to the slide pin within the passage for selectively locking the slide pin in the extended longitudinal position.

5. The device of claim 4, wherein the spring is a compression spring and wherein the first sliding movement of the slide pin towards the extended position causes the compression spring to compress.

6. The device of claim 4, wherein the spring is a tension spring and wherein the first sliding movement of the slide pin towards the extended position causes the tension spring to extend.

7. The device of claim 4, wherein the tubular body includes a transversal aperture communicating with the passage; the trigger mechanism including a button mounted in the transversal aperture so as to extend therefrom; the button selectively engaging the slide pin when the slide pin is in the extended longitudinal position; the biasing member being a first biasing member; the trigger mechanism further including a second biasing member that biases the button in an engaging relationship with the slide pin that locks the slide pin is in the extended longitudinal position.

8. The device of claim 1, further comprising a trigger mechanism mounted to both the body and to the slide pin for selective locking of the slide pin in the extended longitudinal position.

9. The device of claim 8, wherein the slide pin includes at least one locking portion that is configured for engagement with the trigger mechanism to cause the selective locking.

10. The device of claim 9, wherein the slide pin includes a plurality of locking portions longitudinally distanced therealong, each configured for engagement with the trigger mechanism and defining a distinct locking position of the slide pin.

11. The device of claim 9, wherein the slide pin is provided with indicia adjacent the locking portions thereof; the body including a window registered with the indicia for showing the indicium corresponding to the locking portions of the slide pin when the slide pin is in the corresponding locking position.

12. The device of claim 9, wherein the at least one locking portion is a frusto-conical section of the slide pin.

13. The device of claim 9, wherein the at least one locking portion is a notch on the slide pin.

14. The device of claim 1, wherein the body includes a handle.

15. The device of claim 1, wherein the body has two side portions defining a casing that receives the slide pin and the biasing member therein.

16. The device of claim 15, wherein the casing includes a handle portion and a housing portion; the housing portion receiving the slide pin and the biasing member therein.

17. The device of claim 16, wherein the casing includes an aperture for allowing the slide pin to extend out of the casing and inner walls that defines a channel that guides the first sliding movement of the slide pin.

18. The device of claim 15, further comprising a trigger mechanism having I) a finger mounted to the casing therein adjacent the slide pin for selectively engaging at least one locking portion of the slide pin, and II) a trigger member that extends partially out of the casing through an aperture in the casing and that is operatively coupled to the finger; the trigger member being movable between a first position that causes the finger to engage the at least one locking portion of the slide pin and a second position that disengages the finger from the at least one locking portion of the slide pin.

19. The device of claim 18, wherein the biasing member is a first biasing member; the trigger mechanism further including a second biasing member that biases the trigger member towards the first position thereof.

20. The device of claim 18, wherein the finger and trigger member are integral and defines a C-shaped member that is pivotally mounted to the casing therein.

21. The device of claim 18, wherein the trigger member is a generally rectangular body having a finger-receiving aperture therein and that is slidably movable towards and away the slide pin; the finger protrudes from the generally rectangular body towards the slide-pin for selective engagement therewith.

22. The device of claim 1, wherein the impactor is in the form of a C-shaped portion of the slide pin that extends out of the body; a free end of the C-shaped portion defining a tip of the impactor.

23. The device of claim 22, wherein the sliding pin includes a collar that is positioned so as to be in contact with the body when the slide pin is in the neutral longitudinal position along the body.

24. The device of claim 1, wherein the slide pin includes a handle portion that is longitudinally position out of the body.

25. The device of claim 24, wherein the impactor is removably mounted to the handle portion of the slide pin.

26. The device of claim 25, wherein the impactor is in the form of a two-section pin.

27. The device of claim 1, wherein the body includes a grooves that is registered with the impactor parallel thereto.

28. The device of claim 1, further comprising a pin stopper that is secured to the body so as to be positioned within a longitudinal axis defined by the second movement.

29. A device for removing a hinge pin comprising:
a body
a slide pin mounted to the body for first sliding movement between neutral and extended longitudinal positions along the body;
an impactor coupled to the slide pin for second parallel movement in unison therewith;
a spring coaxially mounted about the slide pin and having a first end mounted to the slide pin for solidary movement therewith and a second end abutting a wall within the body; wherein the first sliding movement of the slide pin towards the extended position yields a biasing force onto the slide pin towards the neutral position thereof; and
a trigger mechanism mounted to both the body and the slide pin for selective locking of the slide pin in the extended longitudinal position;
wherein the slide pin includes at least one locking portion that is configured for engagement with the trigger mechanism to cause the selective locking;
whereby, in operation, while i) the impactor is registered with the hinge pin and is distanced therefrom and ii) the slide pin is moved away from the neutral longitudinal position, releasing the slide pin causes a) the slide pin to move towards the neutral position by the biasing member and b) the impactor to impact the hinge pin.
